(19) United States
(12) Patent Application Publication
(10) Pub. No.: US 2016/0034928 A1
(43) Pub. Date: Feb. 4, 2016

(54) SYSTEMS AND METHODS FOR PROMOTIONAL FORECASTING

(71) Applicant: Wal-Mart Stores, Inc., Bentonville, AR (US)

(72) Inventors: Caroline Conway, Bentonville, AR (US); Charles Brandon Fletcher, Bentonville, AR (US); Rahul Chowdhury, Fayetteville, AR (US)

(21) Appl. No.: 14/813,999

(22) Filed: Jul. 30, 2015

Related U.S. Application Data
(60) Provisional application No. 62/030,906, filed on Jul. 30, 2014.

(51) Int. Cl. G06Q 30/02

(52) U.S. Cl. CPC G06Q 30/0202

(57) ABSTRACT

A system for promotional forecasting in a retail environment is provided. The system includes at least one processor coupled to a memory storing sales history information associated with a product, an interface configured to receive a promotion configuration profile including an indication of the product and a state of a plurality of promotion variables, and a promotional forecasting component. The promotional forecasting component is configured to determine a base sales quantity of the product based on the sales history information, determine a lift factor for each promotion variable, the lift factor indicative of an effect of the promotion variable on the base sales quantity, determine a total lift factor for the promotion configuration profile based on the lift factor for each promotion variable and the state of each promotion variable, and determine a forecasted sales quantity for the product based on the base sales quantity and the total lift factor.

### RELATED APPLICATIONS

This application claims priority to U.S. Provisional Application Ser. No. 62/030,906 filed on Jul. 30, 2014, the disclosure of which is incorporated by reference herein in its entirety.

### FIELD OF THE INVENTION

Aspects of the present invention relate to a system and method for promotional forecasting in a retail environment.

### DISCUSSION OF RELATED ART

Retail stores generally purchase products from one or more vendors and sell the purchased products to consumers. Retail stores may entice consumers to purchase particular products by offering various promotions. For example, a retail store may offer a discount on an existing item or run an advertisement displaying a new item. These promotions generally increase consumer demand for the promoted product.

### SUMMARY

Retail stores run promotions on various products to, for example, increase the demand for one or more products. The retail store may need to forecast a demand for a product under various promotional conditions to accurately determine an appropriate quantity of a promoted product to acquire and/or select a particular product to promote. Accordingly, systems and methods for promotional forecasting are provided. Various aspects of systems and methods of promotional forecasting as disclosed herein accurately forecast the demand for one or more products in a retail environment under various promotional conditions.

According to one aspect, a system for promotional forecasting in a retail environment is provided. The system comprises at least one processor coupled to a memory storing sales history information associated with a plurality of products, an interface, executed by the at least one processor, configured to receive a promotion configuration profile including an indication of at least one product of the plurality of products and a state of a plurality of promotion variables and a promotional forecasting component, executed by the at least one processor. The promotional forecasting component configured to determine a base sales quantity of the at least one product based on the sales history information, determine a lift factor for each of the plurality of promotion variables, the lift factor for each promotion variable indicative of an effect of the promotion variable on the base sales quantity, determine a total lift factor for the promotion configuration profile based on the lift factor for each of the plurality of promotion variables and the state of each of the plurality of promotion variables, and determine a forecasted sales quantity for the at least one product based on the base sales quantity and the total lift factor.

In one embodiment, the memory further stores seasonal demand information and wherein the promotional forecasting component is further configured to determine the forecasted sales quantity based on the total lift factor, the sales history information, and the seasonal demand information. In one embodiment, the plurality of promotion variables includes a price discount level, an advertising type, and a placement type. In one embodiment, the promotion configuration profile further includes an indication of at least one retail store participating in the promotion and wherein the promotion configuration component is further configured to determine the total lift factor based on the lift factor for each of the plurality of promotion variables, the state of each of the plurality of promotion variables, the indication of the at least one product, and the indication of the at least one store.

In one embodiment, the promotional forecasting component is further configured to determine the lift factor for each of the plurality of promotional variables based on regression analysis of the sales history information. In one embodiment, the regression analysis identifies relationships between a sales quantity of a product and each of the plurality of promotional variables.

In one embodiment, the interface is further configured to receive realized sales information associated with the indication of the product sold and the state of the promotion variables. In one embodiment, the system further comprises a training component, executable by the at least one processor, configured to update the lift factor for each of the plurality of promotion variables based on the received sales information.

In one embodiment, the promotional forecasting component is further configured to generate a suggested promotion configuration including a suggested state for each of the plurality of promotion variables. In one embodiment, the suggested promotion configuration is forecasted to increase a profit margin of the at least one product.

According to one aspect, a computer implemented method for promotional forecasting in a retail environment is provided. The method comprises storing sales history information associated with a plurality of products, receiving a promotion configuration profile including an indication of at least one product of the plurality of products and a state of a plurality of promotion variables, determining a base sales quantity of the at least one product based on the sales history information, determining a lift factor for each of the plurality of promotion variables, the lift factor for each promotion variable indicative of an effect of the promotion variable on the base sales quantity, determining a total lift factor for the promotion configuration profile based on the lift factor for each of the plurality of promotion variables and the state of each of the plurality of promotion variables, and determining a forecasted sales quantity for the at least one product based on the base sales quantity and the total lift factor.

In one embodiment, the method further comprises storing seasonal demand information and wherein the determining the forecasted sales quantity includes determining the forecasted sales quantity based on the total lift factor, the sales history information, and the seasonal demand information. In one embodiment, the promotion configuration profile further includes an indication of at least one retail store participating in the promotion and the act of determining the total lift factor includes determining the total lift factor based on the lift factor for each of the plurality of promotion variables, the state of each of the plurality of promotion variables, the indication of the at least one product, and the indication of the at least one store.

In one embodiment, the act of determining the lift factor for each of the plurality of promotion variables includes performing regression analysis of the sales history information. In one embodiment, the act of performing the regression analysis includes identifying relationships between a sales quantity of a product and each of the plurality of promotional variables.

In one embodiment, the method further comprises receiving realized sales information associated with the indication of the at least one product sold and the state of the promotion variables. In one embodiment, the method further comprises updating the lift factor for each of the plurality of promotion variables based on the received sales information.

In one embodiment, the method further comprises generating a suggested promotion configuration including a suggested state for each of the plurality of promotion variables. In one embodiment, the act of generating the suggested promotion configuration includes identifying a promotion configuration forecasted to increase a profit margin of the at least one product.

According to one aspect, a non-transitory computer readable medium having stored thereon sequences of instruction for promotional forecasting in a retail environment is provided. The instructions including instructions that will cause at least one processor to store sales history information associated with a plurality of products, receive a promotion configuration profile including an indication of at least one product of the plurality of products and a state of a plurality of promotion variables, determine a base sales quantity of the at least one product based on the sales history information, determine a lift factor for each of the plurality of promotion variables, the lift factor for each promotion variable indicative of an effect of the promotion variable on the base sales quantity, determine a total lift factor for the promotion configuration profile based on the lift factor for each of the plurality of promotion variables and the state of each of the plurality of promotion variables, and determine a forecasted sales quantity for the at least one product based on the base sales quantity and the total lift factor.

Any combination and/or permutation of embodiments is envisioned. Other embodiments, objects, and features will become apparent from the following detailed description considered in conjunction with the accompanying drawings. It is to be understood, however, that the drawings are designed as an illustration only and not as a definition of the limits of the present disclosure.

### BRIEF DESCRIPTION OF DRAWINGS

The accompanying drawings are not intended to be drawn to scale. In the drawings, each identical or nearly identical component that is illustrated in various FIGS. is represented by a like numeral. For purposes of clarity, not every component may be labeled in every drawing. In the drawings:

FIG. 1 is a block diagram illustrating a system for promotional forecasting in a retail environment in accordance with at least one embodiment described herein;

FIG. 2 is a block diagram illustrating a system for promotional forecasting in a retail environment in accordance with at least one embodiment described herein;

FIG. 3 is a flow chart illustrating a process for determining a promotional forecast in accordance with at least one embodiment described herein;

FIG. 4 is a flow chart illustrating a process for training the promotional forecasting system in accordance with at least one embodiment described herein; and

FIG. 5 is a block diagram illustrating computing components forming a computer system in accordance with at least one embodiment described herein.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with anyone or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

As described above, retail stores offer promotions for various products that impact the consumer demand associated with the promoted product. Accordingly, aspects of the current disclosure relate to promotional forecasting systems and methods that project the anticipated change in demand for the promoted product based on the particular configuration of the promotion.

Example Promotional Forecasting System

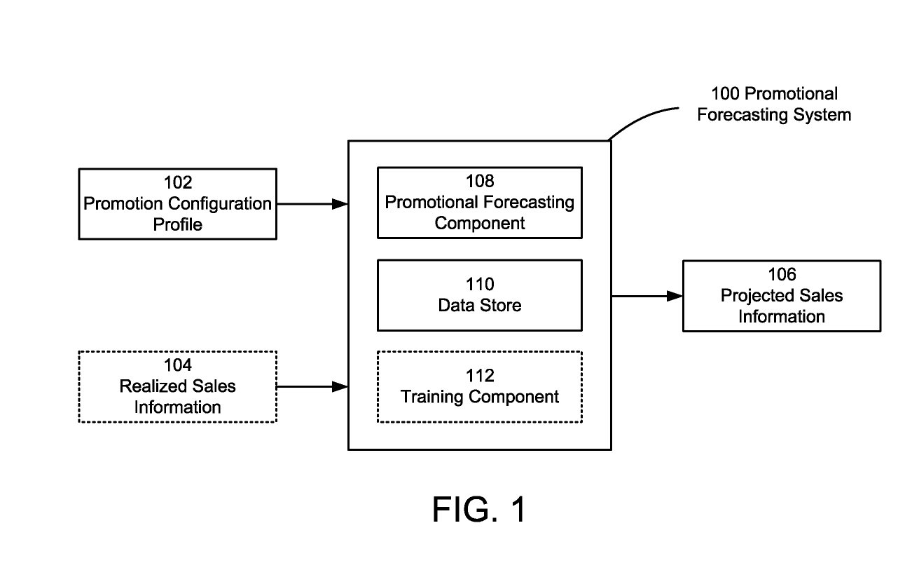

FIG. 1 illustrates a promotional forecasting system 100 constructed to accurately forecast demand for promoted products. The promotional forecasting system 100 receives a promotion configuration profile 102 and optionally realized sales information 104 and outputs projected sales information 106. The promotional forecasting system 100 includes a promotional 30 forecasting component 108, a data store 110, and optionally a training component 112.

The promotional forecasting system 100 generates projected sales information 106 based on the received promotion configuration profile 102. The promotion configuration profile 102 includes an indication of a product and/or service being promoted and a state of a plurality of promotion variables. In one embodiment, the plurality of promotion variables includes a price discount level, an advertising type, and a placement type. In this embodiment, the promotion configuration profile may indicate a promotion for a brand of peanut butter including a 10% discount level, a flyer front page advertising type, and an aisle endcap product placement.

The promotion configuration profile 102 may further include a stock safety factor associated with the indicated product. The stock safety factor may be indicative of the perceived risk of running out of stock. For example, the stock safety factor may indicate that it is critical to not run out of stock of the particular product. In this example, the promotional forecasting component 108 may increase the projected sales quantity to reduce the likelihood of running out of stock.

The promotional forecasting component 108 generates projected sales information 106 including a forecasted sales quantity of a promoted product based on the received promotional

configuration profile 102 and sales history information associated with the promoted product. The sales history information may be stored, for example, in data store 110. In one embodiment, the promotional forecasting component generates the projected sales information 106 by determining a base sales quantity of the promoted product based on the historical sales information. For example, the base sales quantity may be equal to the sales quantity in recent weeks. In this embodiment, the base sales quantity is adjusted based on a plurality of lift factors corresponding to a plurality of promotion variables (e.g., price discount level, advertising type, and placement type). As described in more detail below, each lift factor may be determined by performing a regression analysis on historical data that relates a sales quantity with each of the promotion variables. The lift factors may be calculated and stored in data store 110 and adjusted by, for example, the optional training component 112 to improve the accuracy of the projected sales information 106. The lift factor associated with each of the plurality of promotion variables may be multiplied, respectively, by the state of each promotion variable in the received configuration profile to determine a total lift factor. The total lift factor may be combined with the base sales quantity to determine the projected sales quantity.

The promotion configuration profile 102 may include an indication of the date and/or duration of the promotion. For example, the configuration profile may indicate that the promotion will run for two weeks from a specified future date. In this embodiment, the promotional forecasting component 108 may employ the indication of the date and duration of the promotion to model the effects of seasonal demand changes. For example, consumers may naturally (i.e., without outside influence) purchase more chicken noodle soup in coldest months of the year than in the hottest months of the year. The promotional forecasting component 108 may model the seasonal demand changes by a seasonality index and multiply the seasonality index by the baseline sales quantity and the total lift factor to determine the forecasted sales quantity. The seasonality index may, for example, be stored in data store 110.

In one embodiment, the projected sales information 106 includes a suggested promotion configuration generated by the promotional forecasting component 108. In this embodiment, the promotional forecasting component 108 may change one or more of the plurality of promotion variables to improve a profit margin on the promoted product. For example, the promotional forecasting component 108 may generate a forecasted sales quantity of the promoted product at a plurality of discount levels and select the particular configuration that yields the highest profit margin. The promotional forecasting component 108 may also compare the profit margins associated with promoting a product that is different than the product identified in the received configuration profile 102 and select the particular product and associated promotion configuration that yields the highest profit margin.

In one embodiment, the training optional component 112 improves the accuracy of the projected sales information 106 generated by the promotional forecasting system 100 based on the received realized sales information 104. The realized sales information 104 may include, for example, a realized sales quantity, an indication of the product sold, the state of the promotion variables, and the projected sales quantity generated by the promotional forecasting system 100. The training component 112 may improve the accuracy of the projected sales information by adjusting one or more lift factors associated with the plurality of promotion variables. For example, the training component 112 may adjust the lift factors to reduce the error between the projected sales quantity and the realized sales quantity. The training component 112 may also adjust one or more constants in the model representing the relationship between the various promotion variables and the projected sales quantity.

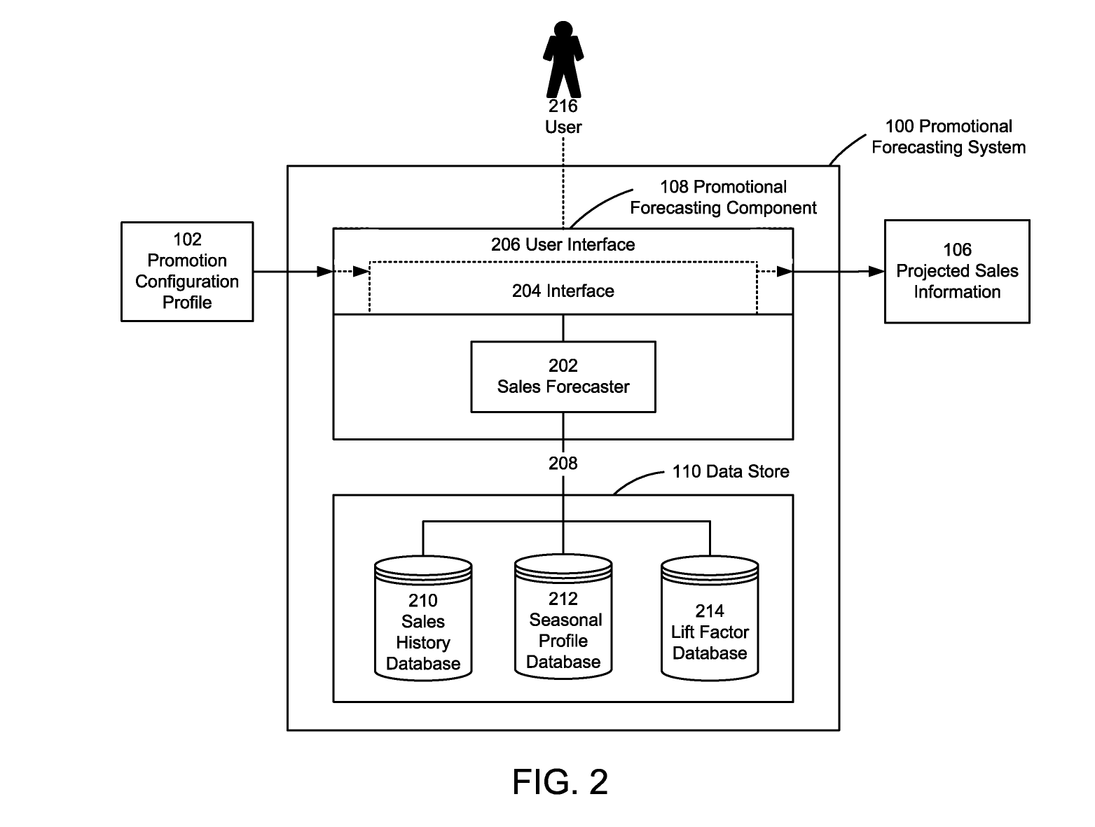

FIG. 2 illustrates another promotional forecasting system 100 constructed to accurately forecast demand for promoted products. The promotional forecasting system 100 receives a promotion configuration profile 102 as an input and outputs projected sales information 106. The promotional forecasting system 100 includes a promotional forecasting component 108 that includes a sales forecaster 202, an interface 204, and optionally a user interface 206. The promotional forecasting component 108 may optionally be controlled by a user 216 via user interface 206. The promotional forecasting component 108 is coupled to a data store 110 via a network 208. The data store 110 comprises a sales history database 210, a seasonal profile database 212, and a lift factor database 214.

In one embodiment, the promotional forecasting component 108 includes an interface 204 configured to receive the promotional configuration profile 102. The promotional forecasting component 108 may optionally include a user interface 206 illustrated as being included in the interface 204. The user interface 206 accepts input from a user 216 regarding the promotion (e.g., the various parameters defining a promotion configuration profile 102) and displays the projected sales information 106. The interface 204 may further accept input from another system. For example, a user 216 may upload the promotion configuration profile to the promotional forecasting component 108 via a device associated with and/or operated by the user 216. It is appreciated that the interface component 204 may be a separate component from promotional forecasting component 108 and does not need to be included within the promotional forecasting component 108.

In one embodiment, the promotional forecasting component 108 further includes a sales forecaster 202. The sales forecaster 202 forecasts the sales quantity for the one or more products specified in the promotion configuration profile 102. The sales forecaster 202 accesses the data store 110 via a network 208 to gather, for example, sales history information from sales history database 210, a seasonal profile index from seasonal profile database 212, and one or more lift factors from lift factor database 214. The information gathered from the data store 110 may be employed to determine the base sales quantity, the effect of the date and/or duration of the promotion, and the total lift factor associated with the promotion configuration to compute the projected sales information 106.

In some embodiments, the data store 110 includes a sales history database 214. The sales history database 214 may store sales history information associated with a plurality of products. The sales history information may include the sales quantity of various products at a one or more retail stores. In these embodiments, the data store 110 may further include a seasonal profile database. The seasonal profile database may store the seasonal demand information (e.g., a seasonality index). The data store 110 may also include a lift factor database 214 that stores information associated with the various promotional lift factor (e.g., the lift factor values for each of the plurality of promotional variables).

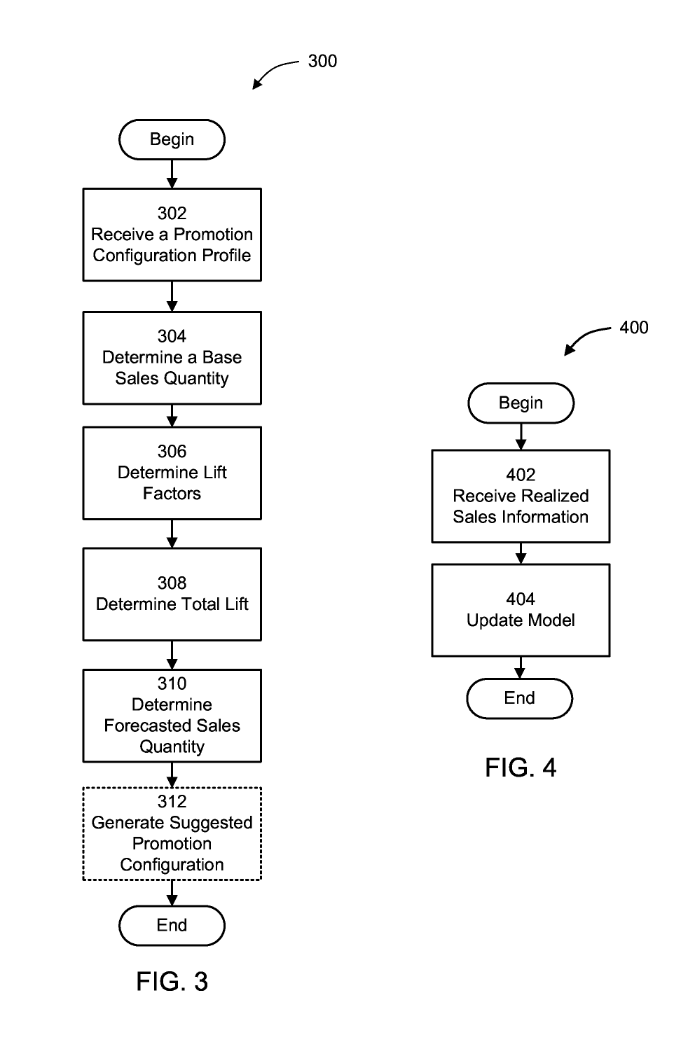

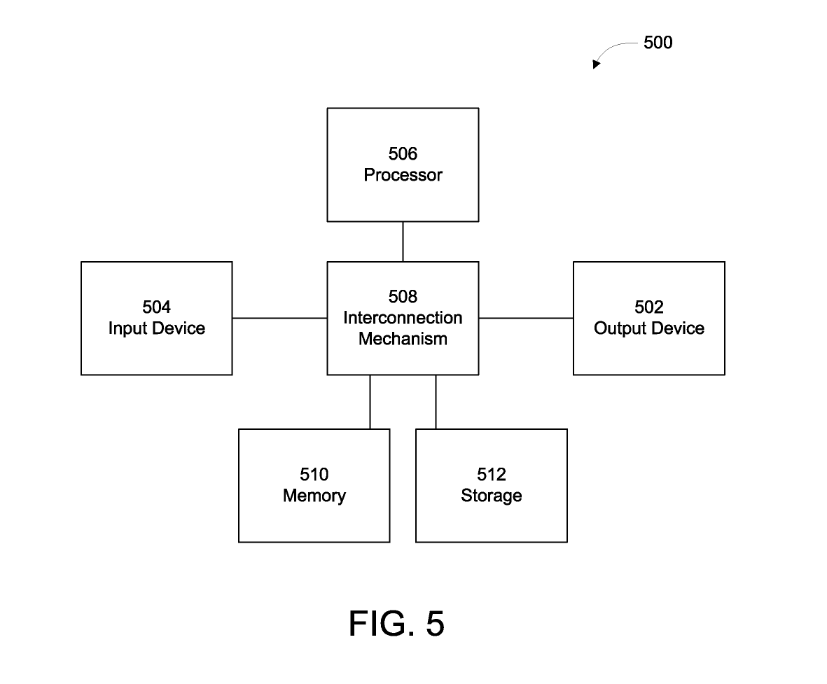

In some embodiments, the components described above with regard to FIGS. 1 and 2 are software components that are executable by, for example, a computer system. In other embodiments, some or all of the components may be implemented in hardware or a combination of hardware and software. Other example promotional forecasting processes are described below with reference to FIGS. 3 and 4 that may be executed by a computer system such as the computer system described below with reference to FIG. 5.

### Example Promotional Forecasting Processes

As described above with reference to FIGS. 1 and 2, several embodiments perform processes that generate a projected sales quantity of one or more products under various promotional conditions. In some embodiments, these promotional forecasting processes are executed by a microprocessor-based computer system, such as the computer system 500 described below with reference to FIG. 5. FIG. 3 illustrates one example promotional forecasting process 300. The promotional forecasting process 300 begins in act 302.

In act 302, the system receives a promotion configuration profile. The promotion configuration profile includes an indication of the product being promoted and information that defines the various parameters of the promotion including, for example, a state of a plurality of promotion variables. In act 304, the system determines a base sales quantity of the indicated product in the received promotion configuration profile. The base quantity of sales may be determined based on, for example, recent sales history information associated with the particular product.

In act 306, the system determines one or more lift factors associated with a plurality of promotion variables. The lift factors may be determined based on one or more regression analysis techniques. In one embodiment, the lift factors are determined based on a multiple linear regression analysis. Multiple linear regression analysis relates a dependent variable with one or more independent variables. A multiple regression model is illustrated below in equation (1):

y=α+β₁*X₁+β₂*X₂+ . . . +βₙ*Xₙ+e (1)

In equation (1), the term y is the dependent variable that is represented as a combination of independent variables X₁ through Xₙ. The terms β₁ through βₙ are coefficients associated with the independent variables X₁ through Xₙ. The term a is a constant that is the y-intercept of the model. The term e is an error value representing the difference between the actual value of dependent variable y and the projected value of y based on a state of the independent variables X₁ through Xₙ and their associated coefficients β₁ through βₙ.

In one embodiment, the linear regression model illustrated in equation (1) is employed to determine one or more lift factors including, for example, a store index lift factor, an item index lift factor, a discount percentage lift factor, a price position lift factor, and a tab position lift factor. In this embodiment, the independent variable coefficients β₁ through βₙ are the lift factors associated with the independent variables X₁ through Xₙ (e.g., store index, item index, discount percentage, price position, and tab position). The dependent variable y is equal to a total lift. The total lift may be calculated based on sales data for a given period of time, seasonal data associated with the period of time and information regarding state of the independent variables. For example, the dependent variable y may be determined consistent with equation (2) illustrated below:

$$y = \frac{C + \frac{{Q}_{sold}}{{I}_{season}}}{C + {Q}_{base}} \qquad ( 2 )$$

In equation (2), the term Q_{sold} is the quantity of units sold and Iₛₑₐₛₒₙ is a seasonality index. The quantity of units sold divided by the seasonality index represents the de-seasonalized quantity of units sold. The term Q_{base} base represents the base quantity of units sold. The base quantity of units sold may be representative of the number of units sold without the influence of promotional variables. The term C is a constant to normalize dependent variable y.

Given the relationship between dependent variable y and the quantity of units sold as represented in equation (2), the lift factors (i.e., the coefficients β₁ through βₙ in equation (1)) may be determined based on previous sales data. For example, values of the various lift factors may be determined that minimizes the error term (e.g., the variable e in equation (1)). It is appreciated that other regression models aside from the regression model illustrated in equation (1) may be employed to determine one or more lift factors including, for example, a non-linear regression In act 308, the system determines a total lift factor based on the determined lift factors.

In one embodiment, the total lift is determined consistent with the equation (3) below model.

Lₜₒₜₐₗ=1+(K+P_{discount}*L_{discount}+P_{price}*L_{price}+Iₛₜₒᵣₑ*Lₛₜₒᵣₑ+Iᵢₜₑₘ*Lᵢₜₑₘ+Iₚₒₛᵢₜᵢₒₙ*Lₚₒₛᵢₜᵢₒₙ) (3)

In equation (3), the term Lₜₒₜₐₗ is the total amount of lift based on the promotion configuration. The terms L_{discount}, L_{price}, Lₛₜₒᵣₑ, Lᵢₜₑₘ, and Lₚₒₛᵢₜᵢₒₙ are lift factors associated with the product discount, the price position, the store, the item, and the tab position respectively. The values of the lift factors may be determined consistent with various regression analysis models as previously described. K is a constant determined consistent with the employed regression analysis model (e.g., variable a in equation (1)). The terms P_{discount}, P_{price}, Iₛₜₒᵣₑ, Iᵢₜₑₘ, and Iₚₒₛᵢₜᵢₒₙ are inputs (e.g., from the promotion configuration profile) that illustrate the particular promotional configuration being forecasted. The term P_{discount} is the percentage of the discount represented by the difference between the normal price and the feature price divided by the normal price as illustrated in equation (4) below:

$${P}_{discount} = \frac{{P}_{normal} - {P}_{feature}}{{P}_{normal}} \qquad ( 4 )$$

The term P_{price} is the price position represented by adding the normal price with the feature price and dividing the sum by two as illustrated in equation (5) below:

$${P}_{price} = \frac{{P}_{normal} + {P}_{feature}}{2} \qquad ( 5 )$$

The term Iₛₜₒᵣₑ is the store index which represents the performance of each store relative to other stores. The term Iitem represents the performance of each item with reference to other items in the store. The term Iₚₒₛᵢₜᵢₒₙ represents the placement of the item in the store. In act 310, the system determines the forecasted sales quantity of the promoted product. The forecasted sales quantity of the promoted product may be determined based on the base sales quantity computed in act 304 and the total lift computed in act 308. In one embodiment, the promotional forecast is generated consistent with equation (6) below:

Q_{forecast}=((C+Q_{base})*Lₜₒₜₐₗ−C)*(Iₛₑₐₛₒₙ*T) (6)

In equation (6), the term Q_{forecast} is the forecasted quantity of goods sold given the received promotion configuration and the term C is a constant to normalize the total lift Lₜₒₜₐₗ. The term Iₛₑₐₛₒₙ is a seasonality index and the term T is the length of the time period (e.g., number of weeks). The term Q_{base} is the base quantity of goods sold.

In optional act 312, the system generates a suggested promotion configuration. In one embodiment, the system generates a suggested promotion configuration that maximizes a profit margin from the promoted product. In this embodiment, the system may balance one or more costs associated with each promotion variable and the forecasted change in demand for the promoted product to determine the suggested promotion configuration.

FIG. 4 is a flow chart illustrating a promotional forecasting system training process 400. The training process 400 improves the accuracy of the forecasted sales quantity of the promoted product generated by the system based on realized sales information associated with a forecasted sales quantity previously generated by the system. The training process 400 begins in act 402.

In act 402, the system receives realized sales information. The realized sales information may include, for example, a realized sales quantity, an indication of the product sold, the state of the promotion variables, and the projected sales quantity previously generated. In act 404, the system updates the model relating the various promotional variables to the projected sales quantity. Updating the model may include revising one or more lift factors. For example, the system may update the lift factors to reduce the error between the projected sales quantity and the realized sales quantity. The system may further update one or more constants in the regression model. For example, the system may update the constant C in equation (2) and/or the constant K in equation (3) to reduce the error between the projected sales quantity and the realized sales quantity.

Furthermore, various aspects and functions described herein in accord with the present disclosure may be implemented as hardware, software, firmware or any combination thereof. Aspects in accord with the present disclosure may be implemented within methods, acts, systems, system elements and components using a variety of hardware, software or firmware configurations. Furthermore, aspects in accord with the present disclosure may be implemented as specially-programmed hardware and/or software.

### Example Computer System

FIG. 5 illustrates an example block diagram of computing components forming a system 500 which may be configured to implement one or more aspects disclosed herein. For example, the system 500 may be configured to perform one or more promotional forecasting processes as described above with reference to FIGS. 3 and 4.

The system 500 may include for example a general-purpose computing platform such as those based on Intel PENTIUM-type processor, Motorola PowerPC, Sun UltraSPARC, Texas Instruments-DSP, Hewlett-Packard PA-RISC processors, or any other type of processor. System 500 may include specially-programmed, special-purpose hardware, for example, an application-specific integrated circuit (ASIC). Various aspects of the present disclosure may be implemented as specialized software executing on the system 500 such as that shown in FIG. 5.

The system 500 may include a processor/ASIC 506 connected to one or more memory devices 510, such as a disk drive, memory, flash memory or other device for storing data. Memory 510 may be used for storing programs and data during operation of the system 500. Components of the computer system 500 may be coupled by an interconnection mechanism 508, which may include one or more buses (e.g., between components that are integrated within a same machine) and/or a network (e.g., between components that reside on separate machines). The interconnection mechanism 508 enables communications (e.g., data, instructions) to be exchanged between components of the system 500.

The system 500 also includes one or more input devices 504, which may include for example, a keyboard or a touch screen. An input device may be used for example to configure the measurement system or to provide input parameters. The system 500 includes one or more output devices 502, which may include for example a display. In addition, the computer system 500 may contain one or more interfaces (not shown) that may connect the computer system 500 to a communication network, in addition or as an alternative to the interconnection mechanism 508.

The system 500 may include a storage system 512, which may include a computer readable and/or writeable nonvolatile medium in which signals may be stored to provide a program to be executed by the processor or to provide information stored on or in the medium to be processed by the program. The medium may, for example, be a disk or flash memory and in some examples may include RAM or other non-volatile memory such as EEPROM. In some embodiments, the processor may cause data to be read from the nonvolatile medium into another memory 510 that allows for faster access to the information by the processor/ASIC than does the medium. This memory 510 may be a volatile, random access memory such as a dynamic random access memory (DRAM) or static memory (SRAM). It may be located in storage system 512 or in memory system 510. The processor 506 may manipulate the data within the integrated circuit memory 510 and then copy the data to the storage 512 after processing is completed. A variety of mechanisms are known for managing data movement between storage 512 and the integrated circuit memory element 510, and the disclosure is not limited thereto. The disclosure is not limited to a particular memory system 510 or a storage system 512.

The system 500 may include a general-purpose computer platform that is programmable using a high-level computer programming language. The system 500 may be also implemented using specially programmed, special purpose hardware, e.g. an ASIC. The system 500 may include a processor 506, which may be a commercially available processor such as the well known Pentium class processor available from the Intel Corporation. Many other processors are available. The processor 506 may execute an operating system which may be, for example, a Windows operating system available from the Microsoft Corporation, MAC OS System X available from Apple Computer, the Solaris Operating System available from Sun Microsystems, or UNIX and/or LINUX available from various sources. Many other operating systems may be used.

The processor and operating system together may form a computer platform for which application programs in high-level programming languages may be written. It should be understood that the disclosure is not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system for promotional forecasting in a retail environment, the system comprising:
at least one processor coupled to a memory storing sales history information associated with a plurality of products;
an interface, executed by the at least one processor, configured to receive a promotion configuration profile including an indication of at least one product of the plurality of products and a state of a plurality of promotion variables; and
a promotional forecasting component, executed by the at least one processor, configured to:
determine a base sales quantity of the at least one product based on the sales history information;
determine a lift factor for each of the plurality of promotion variables, the lift factor for each promotion variable indicative of an effect of the promotion variable on the base sales quantity;
determine a total lift factor for the promotion configuration profile based on the lift factor for each of the plurality of promotion variables and the state of each of the plurality of promotion variables; and
determine a forecasted sales quantity for the at least one product based on the base sales quantity and the total lift factor.

2. The system of claim 1, wherein the memory further stores seasonal demand information and wherein the promotional forecasting component is further configured to determine the forecasted sales quantity based on the total lift factor, the sales history information, and the seasonal demand information.

3. The system of claim 1, wherein the plurality of promotion variables includes a price discount level, an advertising type, and a placement type.

4. The system of claim 1, wherein the promotion configuration profile further includes an indication of at least one retail store participating in the promotion and wherein the promotion configuration component is further configured to determine the total lift factor based on the lift factor for each of the plurality of promotion variables, the state of each of the plurality of promotion variables, the indication of the at least one product, and the indication of the at least one store.

5. The system of claim 1, wherein the promotional forecasting component is further configured to determine the lift factor for each of the plurality of promotional variables based on regression analysis of the sales history information.

6. The system of claim 5, wherein the regression analysis identifies relationships between a sales quantity of a product and each of the plurality of promotional variables.

7. The system of claim 1, wherein the interface is further configured to receive realized sales information associated with the indication of the product sold and the state of the promotion variables.

8. The system of claim 7, further comprising a training component, executable by the at least one processor, configured to update the lift factor for each of the plurality of promotion variables based on the received sales information.

9. The system of claim 1, wherein the promotional forecasting component is further configure to generate a suggested promotion configuration including a suggested state for each of the plurality of promotion variables.

10. The system of claim 9, wherein the suggested promotion configuration is forecasted to increase a profit margin of the at least one product.

11. A computer implemented method for promotional forecasting in a retail environment, the method comprising: storing sales history information associated with a plurality of products;
receiving a promotion configuration profile including an indication of at least one product of the plurality of products and a state of a plurality of promotion variables;
determining a base sales quantity of the at least one product based on the sales history information;
determining a lift factor for each of the plurality of promotion variables, the lift factor for each promotion variable indicative of an effect of the promotion variable on the base sales quantity;
determining a total lift factor for the promotion configuration profile based on the lift factor for each of the plurality of promotion variables and the state of each of the plurality of promotion variables; and
determining a forecasted sales quantity for the at least one product based on the base sales quantity and the total lift factor.

12. The method of claim 11, further comprising storing seasonal demand information and wherein the determining the forecasted sales quantity includes determining the forecasted sales quantity based on the total lift factor, the sales history information, and the seasonal demand information.

13. The method of claim 11, wherein the promotion configuration profile further includes an indication of at least one retail store participating in the promotion and wherein determining the total lift factor includes determining the total lift factor based on the lift factor for each of the plurality of promotion variables, the state of each of the plurality of promotion variables, the indication of the at least one product, and the indication of the at least one store.

14. The method of claim 11, wherein determining the lift factor for each of the plurality of promotion variables includes performing regression analysis of the sales history information.

15. The method of claim 14, wherein performing the regression analysis includes identifying relationships between a sales quantity of a product and each of the plurality of promotional variables.

16. The method of claim 11, further comprising receiving realized sales information associated with the indication of the at least one product sold and the state of the promotion variables.

17. The method of claim 16, further comprising updating the lift factor for each of the plurality of promotion variables based on the received sales information.

18. The method of claim 11, further comprising generating a suggested promotion configuration including a suggested state for each of the plurality of promotion variables.

19. The method of claim 18, wherein generating the suggested promotion configuration includes identifying a promotion configuration forecasted to increase a profit margin of the at least one product.

20. A non-transitory computer readable medium having stored thereon sequences of instruction for promotional forecasting in a retail environment, including instructions that will cause at least one processor to:
store sales history information associated with a plurality of products;
receive a promotion configuration profile including an indication of at least one product of the plurality of products and a state of a plurality of promotion variables;
determine a base sales quantity of the at least one product based on the sales history information;
determine a lift factor for each of the plurality of promotion variables, the lift factor for each promotion variable indicative of an effect of the promotion variable on the base sales quantity;
determine a total lift factor for the promotion configuration profile based on the lift factor for each of the plurality of promotion variables and the state of each of the plurality of promotion variables; and
determine a forecasted sales quantity for the at least one product based on the base sales quantity and the total lift factor.
